(19) United States
(12) Patent Application Publication
(10) Pub. No.: US 2011/0320369 A1
(43) Pub. Date: Dec. 29, 2011

(54) PROJECT MANAGEMENT

(76) Inventor: William James HARKIN, Glasgow (GB)

(21) Appl. No.: 13/222,855

(22) Filed: Aug. 31, 2011

Related U.S. Application Data
(63) Continuation of application No. 10/563,188, filed on May 9, 2006, now abandoned.

(30) Foreign Application Priority Data
Jul. 3, 2003 (GB) 0315541.3

(51) Int. Cl. G06Q 10/00; G06F 17/30

(52) U.S. Cl. 705/310; 707/803; 707/E17.005

(57) ABSTRACT

A method of managing preset and bespoke projects efficiently within a collaborative environment that utilises intranets and or the internet to convey data and messages. In one expression of utility a method of commercialising of proposed intellectual property rights comprising five steps is disclosed. The steps are identifying and protecting intellectual property associated with the invention; developing a prototype product and or end user products based on the intellectual property rights being pursued; identifying and/or developing potential markets for the products; determining a preferred route to market for the products; and, depending on the preferred mute to market, either licensing the invention to 3rd parties and or establishing new companies to bring products to market directly. Also disclosed is a system for implementing the method. The system comprises data storage means including data structures, data processing means in communication with the data storage means, input means and output means.

### RELATED APPLICATIONS

This application is a continuation of U.S. patent application Ser. No. 10/563,188, filed May 9, 2006, the specification and drawings of which are fully incorporated by reference herein.

### FIELD OF THE INVENTION

The present invention relates to a method for commercialisation of inventions and other intellectual property, particularly inventions developed by universities and other academic institutions. The invention is however intended to be applicable to commercialisation of inventions developed by essentially any entity. Certain aspects of the invention relate to computer programs and computer systems for use in the method. Further aspects of the invention relate to computer programs and computer systems for use in the administration of the inventive method, or for use in the administration of other codified methods requiring the performance of multiple distinct yet interacting steps. Yet further aspects of the invention relate to computer software for use in project and document management.

### BACKGROUND OF THE INVENTION

Universities and other educational institutions are largely dedicated towards research, much of which may have commercial applications if developed appropriately. Universities also rely to a large extent on governmental or public funding, which is generally decreasing in availability; the successful commercial exploitation of research may provide some way of supplementing or replacing public funding for such entities.

However, although universities are generally configured toward conducting research, and indeed may have excellent research ratings, their ability to commercialise and exploit research can vary dramatically between universities. Indeed, due largely to a lack of any coherent policy, the exploitation of research may vary between projects within a single institution. The exploitation of research may also vary due to differences in the commercial drive and knowledge of individual researchers.

By exploitation and commercialisation of research is meant in general the development of research or inventions to a position in which the university or other originating entity is able to obtain revenue from the research. The precise manner in which this is done may vary depending on the particular field of research, and depending on what is determined to be the most suitable route to commercialisation. For example, inventions may be patented or not; patents and other intellectual property may be sold or licensed to a third party; or spin-out companies may be formed to hold or to operate the intellectual property. Each of these approaches may be suitable in differing circumstances. The assessment of which approach is suitable is generally a matter for the skilled judgement of the responsible commercialisation department of the university; this is one source of dramatic variations in institution success rates at commercialisation.

In addition, there can be a tension between the different roles of a university, those of research, teaching, and commercialisation, which may lead to inefficiencies in implementing the three roles.

A further obstacle to efficient commercialisation is the level of funding available to the university for development and commercialisation of research. While some public funding may be available, this can be irregular in availability, and is rarely sufficient to bring a product to market. For this reason, external private funding is often sought; however, this too brings problems. In particular, the level of funding sought must be appropriate, and the returns given to the funding party, such as a share in any spin out company, must not be so great that the university is unable to profit from their research. Achieving these desirable goals can be difficult, with the results that an external funder reaps the majority of the reward from a university's innovations.

It is among the objects of embodiments of the present invention to obviate or alleviate these and other disadvantages of current methods of commercialising research or inventions. In certain embodiments of the invention, this is achieved by the provision of a particular sequence of steps to be performed in a commercialisation methodology, which will generally result in an effective commercialisation route. It will of course be understood that effective commercialisation cannot be guaranteed in all cases, since any commercialisation is subject to external forces such as input of creative business strategies involving entrepreneurial activities, and the nature of the relevant market.

It is further among the objects of certain embodiments of the invention to provide a project management tool which may be used for the management of a commercialisation project. Certain aspects of the invention also have the object of providing a general project management tool which may be used to manage alternative projects.

### SUMMARY OF THE INVENTION

According to a first aspect of the present invention, there is provided a method of commercialising an invention, the method comprising the steps of:

a) identifying and protecting any intellectual property associated with the invention;

b) developing a prototype of a commercial product based on the invention;

c) identifying and/or developing potential markets for the product;

d) determining a preferred route to market for the product;

e) if the preferred route to market includes licensing the invention to a third party, then negotiating an appropriate license deal based on the results of steps a) to c), and terminating the method;

f) if the preferred route to market includes creating a spin out company, developing a business plan for the spin out based on the outcomes of steps a) to c); recruiting a management team for the spin out, and identifying and approaching potential investors; engaging with selected investors; and launching the spin out company.

The present method thus allows an invention to be progressed from an initial inventive concept, through product development and market research, to either concluded license deals, or launched spin out companies to exploit the invention. The particular sequence and arrangement of steps has been developed to provide a rigorous procedure which may be followed to maximise the likelihood of successful commercialisation, as well as to provide the opportunity for creating an audit trail as each stage of the method is followed. In addition, embodiments of the method are intended to make it easier to exert quality control over the sequence of discrete steps, thereby improving the eventual outcome of the method.

Step a) may further comprise the step of acquiring complementary intellectual properties associated with the invention; this may include seeking any necessary licences or rights to use relevant intellectual property, or may include forming partnerships or agreements with holders of such property. This step allows an invention to be more fully exploited by assembling a portfolio of relevant intellectual property, even if the portfolio is not solely devoted to property newly-created as part of the invention.

In preferred embodiments of the invention, the steps are performed in parallel, but with staggered commencements. In particularly preferred embodiments, steps a) to c) are commenced first, while steps d) to f) are commenced subsequently. The performance of the steps in parallel as described allows the method to reach a conclusion in a significantly shorter period of time than conventional methods. Thus, the invention will be exploited more rapidly, and to a higher quality commercial outcome, and the entity owning the invention will receive a return from the invention more rapidly than with conventional commercialization strategies and project management methods. The particular commencement timing of each step may be further refined; for example, it is preferred that step a) be commenced shortly before steps b) and c), to allow a supportable IP position to be identified, if not protected, before proceeding further with the method. In particular instances, it has been found that an overall time scale of 6 to 12 months can be sufficient for commercialising an invention: step a) is begun at time zero, steps b) and c) after two or three weeks, step d) and the development of a business plan after three months from time zero; recruitment of a management team after another month; and launch of a company in around six to twelve months. The precise timescales of the present method will of course vary according to particular conditions of the invention to be commercialised.

The method preferably comprises the step of terminating the method in the event that any of the steps a) to f) do not provide satisfactory results, which may be when the steps are still ongoing rather than only when the step reaches a conclusion. For example, if the intellectual property which is identified in step a) is determined as unprotectable for some reason, then the method may be terminated. Or, if steps a) and b) are proceeding satisfactorily, but step c) determines that potential markets for the product are too small to provide satisfactory returns, then the method may be terminated. This has the advantage that the method is halted as soon as a negative assessment is reached in any of the steps; when combined with parallel implementation of the steps of the method, this ensures that any potential difficulties become apparent relatively early in the process, and that a decision may be made to terminate the method and so reduce wastage of resources. It will be understood that the particular criteria by which outcomes may be determined as ‘satisfactory’ will of course depend to a large extent on the particular details of the invention to be commercialised. For example, specialist medical technology for which there are no current competitors may be profitable with a smaller market size than a more general technology which must compete in a crowded marketplace.

Alternatively, or in addition, the method may comprise the step of revising any of the steps which do not appear to be performing satisfactorily. For example, particular management candidates or investors may be replaced, or an initially promising but ultimately poor licence agreement may be cancelled or revised. The nature of the present method is such that these revisions may be more easily performed than otherwise.

Preferably the step of identifying and protecting intellectual property may include the step of identifying possible future developments of the invention which may lead to further intellectual property. For example, an assessment of an invention at an early stage of development may result in a patent application being filed to protect the invention in broad terms, while the possibility of subsequently protecting more specific applications of the invention may also be noted. Subsequent research by the inventor may be directed toward realising these possibilities to allow a broad patent portfolio to be built up.

Intellectual property may be protected in any suitable form, such as patents, trade marks, utility models, design registrations, copyright, and the like. Over the likely timescales to which the present method will generally be applied, it is unlikely that granted patents may be obtained; in this case, ‘protection’ simply refers to ensuring that a patent application has been filed, if appropriate. Similar considerations apply to other forms of intellectual property.

Preferably the development of a prototype includes the steps of designing a prototype, and production of a prototype. While the inventor may be involved in these steps if appropriate, it is preferred that the inventor does not determine when the design stage has finished and when the production stage is to begin. This is because inventors may not be aware of all the considerations regarding commercialization of the invention, and it may be necessary for a third party such as a project manager or the like to take a decision to cease design and commence production, even if the inventor would prefer to continue the design stage.

Preferably the method further comprises the step of appointing a project manager to oversee the commercialization method. As with the prototype step discussed above, while in some cases an inventor may be equipped for progressing the commercialisation method, the majority of the time a separate manager will be preferred. The manager may provide experience of previous commercialisations to the project, and is less likely than the inventor to wish to commercialise the invention ‘at any cost’—if the invention proves unlikely to be successful, a separate manager will be more able to terminate the method than the inventor will be.

Preferably the method further comprises the step of preparing a project plan prior to commencing the remainder of the steps of the method. A typical plan may include a series of goals and strategies to be followed for implementation of each of the steps of the method. The progress of the plan is preferably monitored by a project manager, as well as other administrative staff if such are involved in the method, at regular intervals. The plan is preferably updated at regular intervals, to take account of progress in each of the method steps. In a typical implementation of the method, the project plan will be monitored and updated at monthly intervals, although other time intervals may be preferred if appropriate.

Preferably the implementation of any or all of steps a) to f) of the method is modified throughout the period of implementation to take account of outcomes of any or all of the remaining steps of the method. That is to say, the steps of the method provide feedback to one another which enables the implementation to be modified as necessary. For example, the nature of any potential markets for the product may affect the preferred route to market, as well as details of a final commercial product, and avenues for future research and intellectual property protection. These modifications may be effected together with the modifications to the project plan.

Preferably certain of the steps or parts of steps of the method are to be performed by third parties. It may be that certain of the steps are subcontracted to outside agencies. This is intended to allow the method to be implemented by a body, such as a university Enterprise department, without necessarily requiring all of the skills needed ‘in-house’. In addition, subcontracting allows specialists to perform the specialised tasks (for example, market research, patent and other IP protection, prototype modelling, and the like) for which they are suited, while the project administrators may simply oversee the project without requiring to become involved in specialist tasks. Subcontracting also generally permits such tasks to be completed more rapidly, to a higher quality, and at lower cost than would otherwise be possible.

It will be noted that the present invention may require the preparation of a number of types of documents during its implementation. For example, project plans, invention disclosure forms for use in protection of intellectual property, licence agreements, business plans, contracts for outside suppliers and the like. Preferably one or more of these types of documents may be drawn up based on a database of ‘standard’ document templates. In preferred embodiments of the present invention, a database is provided having templates for each type of document which may be needed. The database may be a computer database. Access to the database may be permitted via a remote communications link, for example via the internet; this allows different steps of the project to be performed or coordinated at different locations; or for several different projects to be administered from a single database. Administrators or others having suitable access privileges to the database may upload new templates and update existing templates on the database.

Once documents have been prepared from the templates, they may then be stored in an accessible database for use by project participants. Again the database may be accessible via a remote communications link. Preferably the stored documents are modifiable by users. This allows project documents to be accessed and modified remotely, for example by subcontractors located elsewhere than the project manager. A networked document model also permits different project participants to interact with one another and with project documents via communications links; in this way a project may be subcontracted to widely dispersed specialists who may all be able to interact fully in the project. Particular users may be given access to only a selection of projects (if more than one project exists) or a selection of project documents within a particular project; for example, a subcontractor may be allowed access only to those documents relevant to their contract, while the project manager may be permitted access to all documents.

According to a second aspect of the present invention, there is provided a system for use in commercialisation of an invention, the system comprising:

data storage means including data structures representing templates for documents for use in commercialization of an invention;

data processing means in communication with the data storage means, for retrieving and manipulating the data structures;

input means for inputting data and commands to the data processing means; and output means for outputting manipulated data structures from the data processing means.

This permits a user such as a project manager to prepare project documents based on predefined templates by amending the templates to reflect particular conditions of the project.

The output means may comprise a hard copy output device, such as a printer, plotter, or the like; or the output means may comprise a data storage device, such as a disc drive, tape drive, hard drive, CD-writer, or similar device.

Preferably however the output means comprises a remote communications link to one or more further data processing means. This permits project documents to be prepared and communicated to other project participants, for example via the internet or similar network.

Preferably a plurality of data processing means and input means are provided. This allows multiple users to manipulate the data structures, so enabling cooperative preparation of project documents. A single master document may be manipulated by multiple users, or multiple documents may be manipulated independently.

The system may further comprise means for real time communication between data processing means; for example, videoconferencing, internet telephony, text-based messaging, or the like. Users of the system may thus discuss modifications to the project documents while being able to simultaneously implement such modifications. Alternatively, or in addition, the system may comprise non-real time communication means, such as email or webmail facilities this allows messages to be sent between project participants. In certain embodiments of the invention, the communication means may facilitate communication only with project participants; for example, a webmail system may be configured to permit communication only with a predefined list of recipients. The predefined list may be specific to a particular project or document, such that only those participants with access to a particular document may be permitted to discuss that document via webmail.

The system may further comprise access regulation means, for example, system privileges, password protection, or the like, to permit authorised users different levels of access to data structures.

The data structures included in the invention may be selected from one or more of: project plans, invention disclosure forms, licence agreements, business plans, contracts for outside suppliers, and the like.

The skilled person will appreciate that a system or computer program designed for the implementation or administration of the method of the present invention may be equally applicable to activities other than commercialization of inventions. In fact, it is considered that the system or program may be of use in connection with essentially any methodology which may be codified as a number of discrete yet interacting activities. Thus, further aspects of the present invention are not intended to be limited to use in connection with commercialisation of inventions.

According to a further aspect of the present invention, there is provided a project management tool, the tool comprising:

data storage means including data structures representing templates for documents for use in management of a project;

data processing means in communication with the data storage means, for retrieving and manipulating the data structures;

input means for inputting data and commands to the data processing means; and

output means for outputting manipulated data structures from the data processing means.

According to a still further aspect of the present invention, there is provided a computer program for administering a procedure comprising a number of discrete yet interacting activities, the computer program comprising:

computer code for displaying and allowing user selection of a plurality of clients;

computer code for displaying and allowing user selection of a plurality of projects associated with a selected client;

computer code for displaying and allowing user selection of a plurality of activities associated with a selected project;

computer code for displaying and allowing user selection of a plurality of documents associated with a selected activity; and

computer code for allowing user selection of a document, and display of a selected document.

Thus, the present invention provides a hierarchical arrangement whereby a user may monitor and administer activities within a particular project being conducted on behalf of a particular client. The hierarchical arrangement allows users to administer multiple clients, projects, and activities efficiently, and provides more efficient navigation through a series of documents and details of projects.

The computer program may further comprise computer code for flagging particular documents to allow user selection of those documents only when certain other documents have been previously flagged. For example, the hierarchical arrangement of documents may correspond to steps in a particular process to be undertaken; in this case, documents may be flagged to permit user selection only once particular steps (such as viewing or completion of a document) have been previously undertaken. This can help to ensure that the hierarchical organisation of documents is maintained when those documents are used in management of a project. The flagging and arrangement of documents may be editable by users with suitable access privileges, such as administrators.

The computer program may be provided in the form of a computer program product comprising computer code stored on a suitable data carrier. Alternatively, or in addition, the computer program may be provided in the form of computer code transmitted as data over an electromagnetic communications network; for example, the internet or similar computer network.

For brevity in the following paragraphs, clients, projects, activities, and documents will be collectively referred to as ‘items’; except where otherwise indicated, it will be understood that the term ‘item’ refers to any or all of clients, projects, activities, and documents.

The code for displaying and allowing user selection of items may comprise code for displaying and allowing user selection of hyperlinks, with brief details of each item being displayed, while the user may select a particular hyperlink to display the next item in the hierarchy. Conventional hyperlink navigation tools may be used; for example, a conventional internet browser. Alternatively, a dedicated navigation tool may be provided. Thus, each item may be displayed in the form of a short title or summary, which may be a hyperlink to the item itself (for example, a text document, graphic file, HTML or other webpage format, or the like). User selection may take the form of clicking on the hyperlink with a computer mouse or other selection tool. Alternative selection mechanisms may of course be employed.

The computer program may further comprise computer code defining participants in a particular activity, and computer code for permitting a user to write messages to be communicated to any or all participants in that activity. For example, messages may be communicated to a participant by means of email or a similar system; or messages may be stored and communicated to the participant at a future time when the participant logs in to a computer executing the computer program. A ‘participant’ in an activity may be any party who has an interest in being involved in or informed of the activity. The communication system may be restricted to permit messages only to such participants.

The program may further comprise computer code for displaying the progress of the activities to a user. For example, the activities may be displayed as graphic bars indicating the percentage completion of each of the activities. The displayed percentages may be altered automatically as items within the activity are defined as completed, or are deleted from the activity.

The program may yet further comprise computer code for retrieving document templates from a data store. These templates may be communicated to activity participants as they are; or may be edited by a user to adapt them to a particular activity.

The program may still further comprise computer code for displaying information regarding any of the items. This information may include, for example, details of the status of the item (ongoing, completed, not yet started); details of participants in that item; planned completion or start dates; and the like. The information may be displayed simultaneously with display of the item itself, or may be displayed separately, for example in a separate sub screen.

According to a still further aspect of the present invention, there is provided a computer program for providing a user interface for administering a procedure comprising a number of discrete yet interacting activities, the computer program comprising:

computer code for displaying and allowing user selection of a plurality of clients;

computer code for displaying and allowing user selection of a plurality of projects associated with a selected client;

computer code for displaying and allowing user selection of a plurality of activities associated with a selected project;

computer code for displaying and allowing user selection of a plurality of documents associated with a selected activity; and

computer code for allowing user selection of a document, and display of a selected document.

The program may further comprise computer code for allowing user editing of a selected document. This may take the form of code for executing a separate editing program (for example, a proprietary word processor or the like) on selection of a document.

The program may further comprise computer code for allowing user communication with further users. For example, the program may comprise code for a webmail or email system or the like; this may be configured to permit communication with a defined list of users, such as those associated with a particular project.

According to a still further aspect of the present invention, there is provided a computer program for configuring an administration procedure for administering a number of discrete yet interacting activities, the computer program comprising:

computer code for allowing user definition of a plurality of activities to be administered;

computer code for allowing user definition of a plurality of documents associated with each defined activity; and

computer code for allowing user selection of a document, and display of a selected document.

Thus the present invention may be used to configure a project management tool by inputting a number of user-defined activities and documents.

The program may further comprise computer code for defining a default set of activities, and/or a default set of documents associated with a particular activity; these default sets may subsequently be edited if desired. This allows rapid set-up of a default activity (for example, commercialization of an invention), and may take advantage of a predefined set of activities and documents which have been found to be generally useful, while still permitting individual customisation.

The computer program may further comprise computer code for allowing user definition of a plurality of stages associated with each defined activity, and the sequence of the stages. This allows each activity to comprise a number of stages which must be completed in sequence before the activity can be completed. The activities may also be given a user-defined sequence if desired.

The computer program may further comprise computer code for allowing user definition of a plurality of projects, each of which comprises a number of activities. In addition, the program may comprise computer code for allowing user definition of a plurality of clients, each of which may comprise a number of projects.

The program may yet further comprise computer code for allowing user definition of a plurality of participants to be associated with activities, documents, and the like. The association may control participant access privileges to documents and the like. The association may be given a default set of values (for example, where a participant is defined as the project manager, they may be given full default access to everything); this may be modified by the user if desired.

### BRIEF DESCRIPTION OF THE DRAWINGS

These and other aspects of the invention will now be described by way of example only and without limitation with reference to the accompanying drawings, in which:

FIG. 1 shows a schematic representation of the stages of commercialisation of an invention in accordance with an embodiment of the present invention;

FIG. 2 shows a system for use in commercialization of intellectual property in accordance with an embodiment of the present invention;

FIG. 3 shows a schematic diagram of the operation of a computer program for administering a procedure comprising a number of discrete yet interacting activities;

FIGS. 4 to 19 show a series of simulated screenshots from a computer program as schematically illustrated in FIG. 3; and

FIGS. 20 and 21 show simulated screenshots from a computer program for administering a project for producing a film for television.

### DETAILED DESCRIPTION OF THE DRAWINGS

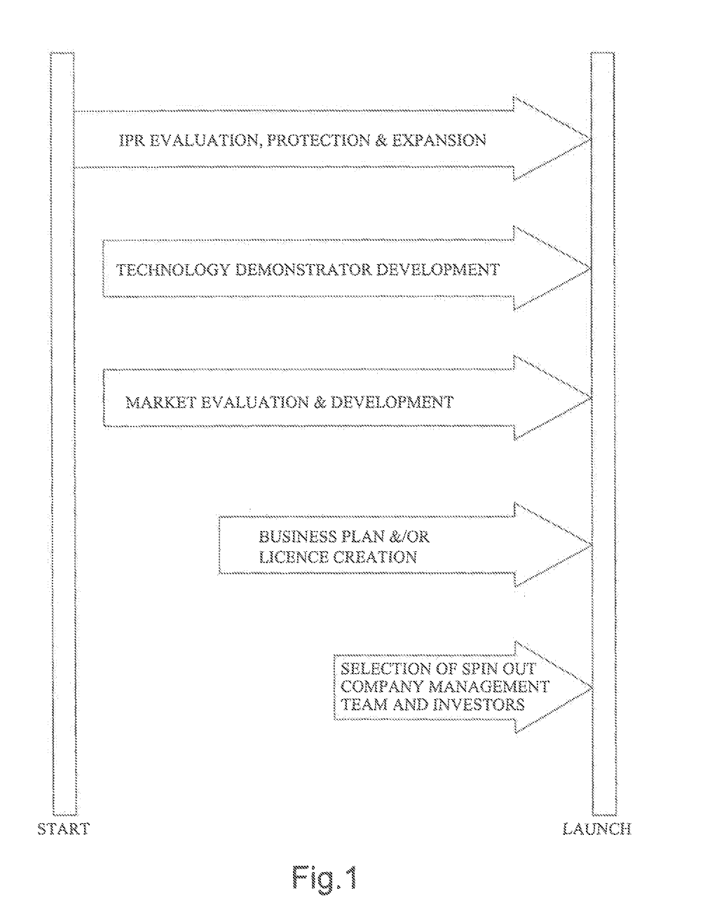

Referring first of all to FIG. 1, this illustrates a method for commercialisation of inventions in accordance with one embodiment of the present invention. The commercialization will typically be carried out on behalf of a university which has a researcher who has made an invention. The Figure illustrates five discrete activities that are managed in parallel within the commercialisation process. A number of the activities have staggered starts, but all proceed in parallel, and terminate at the same time. The five activities are: IPR (intellectual property rights) evaluation, protection and expansion; technical development; market understanding and development; business plan and/or licence creation; and selection of management teams. When a project is first begun, a project manager is designated to take charge of the project, and an initial budget set. A project plan is drawn up on the basis of these five activities, with any necessary modifications to take account of the particular nature of the project. The project plan may be based on a template plan held in a computer database for use by project personnel.

After all five activities are advanced to at least the minimum quality standard, all of the relevant uncompleted contracts for launch of a spin out company are signed by the parties at the final launch point. Of course, certain necessary contracts may be concluded prior to the final launch point, to allow for some staging of contracts; the final launch point is intended to be the point at which all of the contracts have been concluded, if they have not been concluded previously. The process typically takes nine months to develop and launch a spin out company, or to conclude licence deals. Funds from the deal may be returned to the parent institution, such as a university, for further research or commercialization opportunities. In the event that any of the five activities does not reach the minimum standard, the project is terminated; this ensures that all five of the key strands of the project have sufficient basis to proceed with a spin out launch or licence deal.

Although reference is made to completion of all five activities, it will be appreciated that where the outcome of the process is a licence deal, only the first four activities need be undertaken since selection of a management team is not needed. The present description should be read with this in mind.

The five commercialisation activities each have standard development milestones to be achieved. These milestones are:

1. IPR Evaluation, Protection and Expansion

This activity is commenced first. Within this activity all valuable intellectual property rights are identified and applications made for registration (if appropriate) by a suitable professional attorney. In addition to monthly evaluation and budget meetings between the project manager and the lead inventor, there are quarterly meetings which include the selected attorney for updating on the progress of registration and identification of IPR. The identification includes not only identification of currently-existing rights which may be registered, but also identification of potential future developments which may lead to additional useful IPR. External IPR may be identified and acquired, if necessary. All meetings are recorded, and the project plan is updated as necessary.

2. Technology Demonstrator Development

Once an initial basic level of IPR has been identified, sufficient to support the project, the technical development of the project is commenced, together with the market understanding of step 3. Within this activity the ‘paper’ form of the intellectual capital assets being developed under activity 1 are translated into a first physical manifestation. These products or devices are intended simply as the inventor's or project manager's first expression of possible mass-producible and saleable products. The technical development stage includes a design stage and a production stage. Since inventors may be reluctant to enter the production stage with a less than perfect design, the project manager is responsible for the decision to cease design and begin production.

The products or devices selected for production during this stage will have been strongly influenced by the knowledge gained throughout step 3, market understanding and development, which begins simultaneously with technical development and proceeds alongside it. The products will not necessarily be engineered to industry quality nor designed to take into account industry standards, but are simply a demonstration that a product is feasible.

In the interests of speed and quality, all product design and production activities which can be subcontracted to outside agents are so subcontracted. The inventor and project manager will be involved directly only in those activities which cannot be delivered by expert external sources. This philosophy of subcontracting is carried throughout the whole of the present method, and permits projects to proceed rapidly without sacrificing quality. Monthly project management and budget meetings are held between the project manager and the inventor, with the meetings being recorded and the project plan updated as appropriate.

3. Market Evaluation and Development

As mentioned above, this activity commences simultaneously with the technical development stage. The project manager assembles a project team which creates an initial view of the potential market for the project. The project team then approaches the top three or so companies in the market, with a view to discussing the companies' view of the project and the potential market. These discussions, undertaken in confidence, are designed to elicit a fuller understanding of current and anticipated market demands. The discussions may also serve to identify potential early adopters of the technology, and may occasionally identify potential business partners or collaborators. Monthly project management and budget meetings are held, with the meetings being recorded and the project plan updated as appropriate.

4. Business Plan and/or Licence Creation

Once steps 1 to 3 have proceeded for typically three months, the project manager has acquired enough technical and market understanding to allow selection of the preferred route to market for the project. Two main options are possible: direct licensing to existing companies, or the creation of new spin out companies. If the invention is to be licensed, suitable licensees will be identified, and appropriate licence agreements negotiated. The commercialization method terminates at this point, with the signing of the licence agreement. A ‘post-launch’ monitoring and reporting activity may continue beyond this point, to keep track of the performance of the licence agreement.

If a spin out company is to be launched, the method continues and a business plan is written. Within this activity the project manager acts as a ‘surrogate CEO’ for the emerging new company, and is responsible for assembling and verifying the required materials and writing the business plan. A plan template will give guidance on suitable formats for business plans; specific versions of the template may be available for different fields of technology, such as biotechnology or computer-related inventions. As with other aspects of the method, certain parts of the task of writing the business plan may be subcontracted out to third parties; for example, the inventor may prepare a technical section, while an outside accountant may prepare a financial section. Elements of graphic design and branding will also be contracted to specialist agencies.

The business plan is prepared to act as a full expression of the technical capabilities and business opportunities available. A management team for the emerging spin out company will be provisionally identified and engaged (see step 5 below). The estimated first year or so funding requirements will also be set. All key members' expectations will also be addressed and negotiated at the earliest possible stage. For example, the terms of equity shareholding for the inventor, related others such as technicians, the university, and the management team and investors will all be set at this stage. Start salary levels for salaried individuals will also be agreed. With all these matters resolved, the target level of first round funding to be sought will be agreed before any approaches to investors are made; this avoids the possible situation found by a number of start ups, whereby substantial equity holdings and control must be given to outside investors simply to secure early finance.

Monthly project management and budget meetings are held and recorded, and the project plan updated as appropriate.

5. Selection of Spin Out Company Management Team and Investors

Once the business plan has been under development for around one month, the selection of the management team begins. Working from generic recruitment profiles, which again may be based on templates held in a computer database, the project manager will engage recruitment consultants to deliver suitable candidates. The project manager and the inventor, together with any other desired contributors, will select a suitable candidate for each role. The inventor may be engaged as chief scientific officer for the company.

In parallel to the recruitment activities, suitable sector-knowledge-specific investors will be identified, both from available networks and via general market research. Once identified, preferably two or more suitable and equally capable investors will be courted. Over a series of meetings in which the technology offering, market offering, management team, and inventors involved are presented, valuations and conditions are invited from each potential investor. Based on this information, investors will be selected and invited to act as initial investors.

Monthly meetings are held, as with the other stages.

Launch

Once all five of the prelaunch activities are completed (or only four in the case of a licence deal), the project manager will bring together all the remaining required formal contracts. Suitable contract templates may be held in a computer database for use by the project manager. The project manager coordinates the various parties involved, and settles all terms and final execution of the contracts. Certain necessary contracts may be concluded prior to this stage, although it is intended that all contracts are concluded at the launch stage. Once the contracts have been signed, the new spin out company is formally launched, and the method terminates. A ‘post-launch’ monitoring and reporting activity may continue beyond this stage, to assess business performance.

This approach thus leads from the making of an initial invention, through the analysis of potential markets and determination of a route to market, to the creation and launch of a high quality spin out company. The method may generally provide results in the form of a launched company within nine months, a significantly shorter time than conventional methods.

The structured approach followed provides a number of advantages over conventional methods. The emphasis and ordering of each stage is more effective than conventional models. The method provides a complete audit trail of development and launch of the spin out companies or licence deals, thanks to the regular project meetings and reports; further, all draft documents discussed may be archived for future reference. The structured approach also reduces the need for external funding until a late stage in the project, once the majority of the stages are nearing completion. This allows the university to retain a greater say in the development of the company, and reduces the control which external funders may exercise. Further, the risk to which all investors is exposed is reduced, both since there is a rigorous procedure whereby the commercialisation process is halted if any aspect of the various stages is deemed unsatisfactory, but also because the investors will not be providing funds and exercising dominant control until a relatively late stage in the proceedings, such that there is a stronger likelihood that a spin out company will succeed.

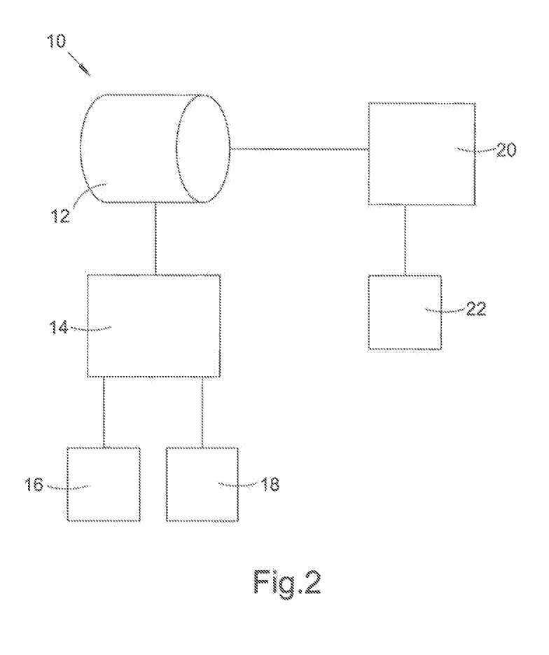

A still further advantage may be gained by use of the system illustrated in FIG. 2 for managing of the process. FIG. 2 shows a system 10 for use in commercialisation of an invention in accordance with an embodiment of the present invention. The system 10 includes a computer database 12, which is in data communication with a computer processor 14. The processor 14 includes a data input device 16, such as a keyboard and mouse, and a data output device 18, such as a printer. A second computer processor 20 having a second data input device 22 is also in data communication with the computer database 12. The data communication between the computer processors 14, 20 and the database 12 may be via direct connections, or may take place over a public or private computer communications network, such as the internet.

The database 12 contains a number of data entries each representing a template for a document which may be used in implementation of the present method. For example, the database 12 may include templates for project plans, business plans, monthly reports, licence agreements, company formation documents, and the like.

When a stage of the method is reached which requires preparation of a document, the appropriate template is retrieved from the database 12 by a user of the first computer processor 14. The template may be requested by means of a web-browser type interface to permit selection of an appropriate template. The template may then be edited by means of the input devices 16 to add or remove relevant sections such that the template is in a suitable form for use in the particular project. The edited document may then be printed in hard copy using the printer 18, or forwarded directly to other participants in the project, using the second processor 20.

Alternatively, templates which are being edited may remain stored on the computer database 12. This allows multiple users to access and amend the document in a single session. Thus, for example, the project manager may be accessing a template for use in development of the product using the first processor 14, while the inventor monitors the amendments using the second processor 20. Since the two processors are in data communication, the inventor may send comments to the project manager using, for example, a conventional email or chat system, as any amendments to the template are made.

It will be understood that multiple terminals may be connected simultaneously to the database, to permit many users to contribute to the preparation of a document. Further, where the completed documents are retained on the database 12, users may subsequently access the documents should it be necessary to refer to them.

In certain embodiments of the system, each document or template may be security protected, such as by means of a user authentication system or the like, and users may be permitted access only to certain of the documents or templates depending on their role within the project team. For example, patent attorneys may be given access only to patent documents and product development documents; while investors may be permitted to access the business plan. Users may also be restricted in their permission to edit templates, if they will not generally need to create documents.

Thus, use of this system to implement the commercialization method permits multiple parties to work together to develop the spin out company without the need for face to face meetings. This results in greater involvement for all parties throughout the process, and in cost savings since fewer physical meetings are necessary.

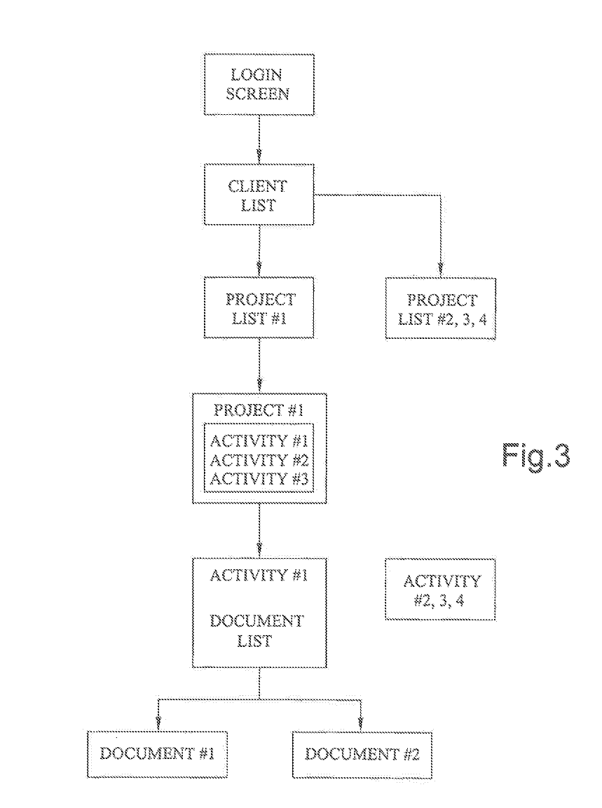

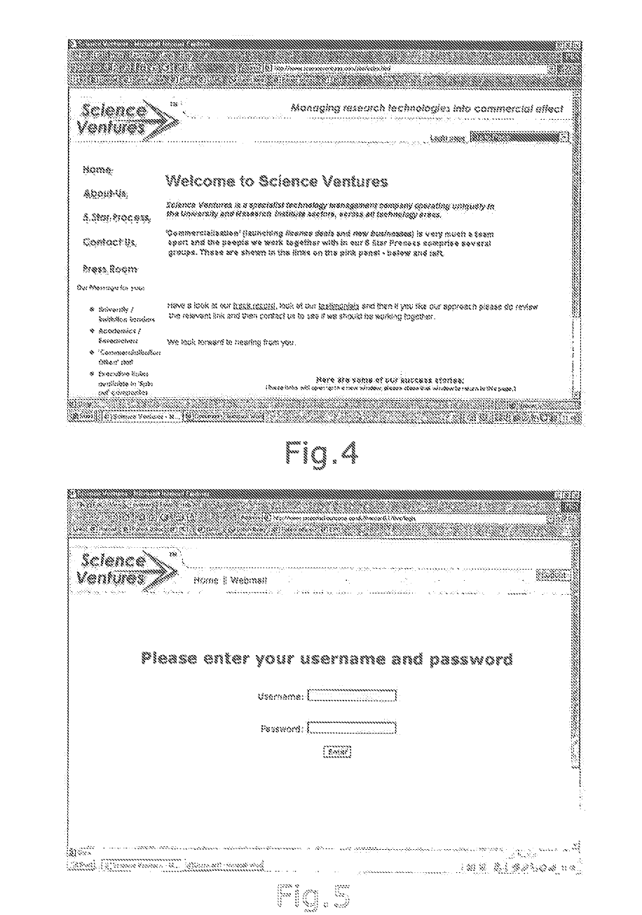

Referring now to FIG. 3, this shows schematically the organisation of a computer program for administering a procedure comprising a number of discrete yet interacting activities. The computer program will be described herein and with reference to FIGS. 4 to 19 as applied to the method for commercialisation of inventions described above, but it will be apparent that the computer program may find additional applications, as will be discussed below.

Use of the computer program may be as follows. The program may be operated on a networked computer terminal, which has access to a data storage device and a computer network, such as the internet. The program may operate much as a web browser, allowing a user to access a front page (FIG. 4) presenting initial information regarding the entity which is operating the method. The front page may be accessed via a network, for example, as an internet web page, or from local data storage. The front page provides a number of links to additional pages supplying further information, as well as a link to allow users to log in to a secure area of the website. An example login screen is shown in FIG. 5.

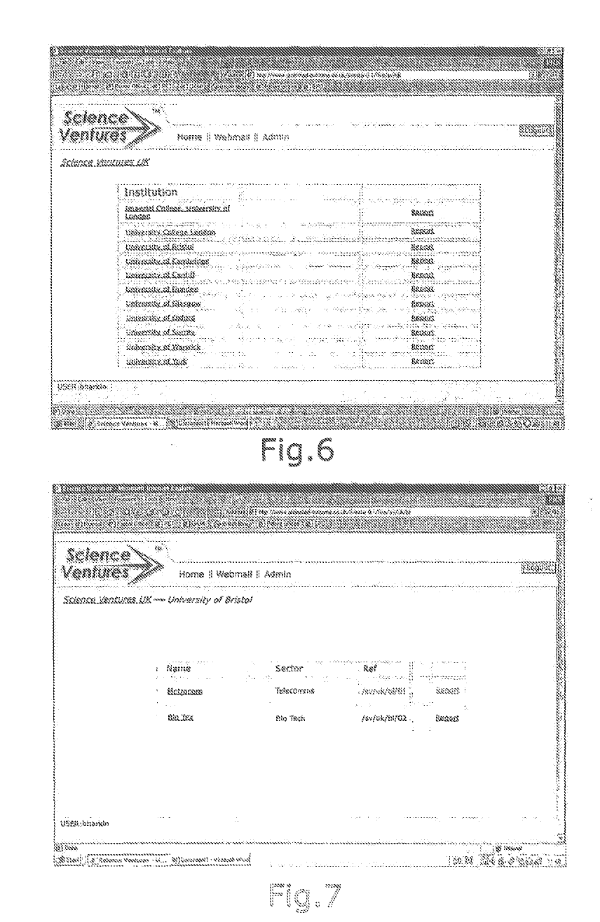

Once the user has logged in to the website, they are presented (FIG. 6) with a list of all clients currently engaged with the operator and to which the user has access. From the client list, the user may elect to access a report repository containing reporting documents relevant to that particular client, if desired, such as the accounts, annual report, and the like. The user may instead select a particular client (in this example, by clicking on the displayed name of the client using a mouse or similar input device), which then accesses a list of projects being undertaken for that client (FIG. 7). This project list presents a series of hyperlinks in the form of the titles of each project, together with details of a reference code for the project, and a further hyperlink allowing access to project reports from a report repository. The project list may also indicate the status of the project (that is, whether the project is ‘live’, ‘on hold’, ‘closed’, or the like). The project status indicator may take the form of a pull-down menu, which may be amended by suitably authorised users.

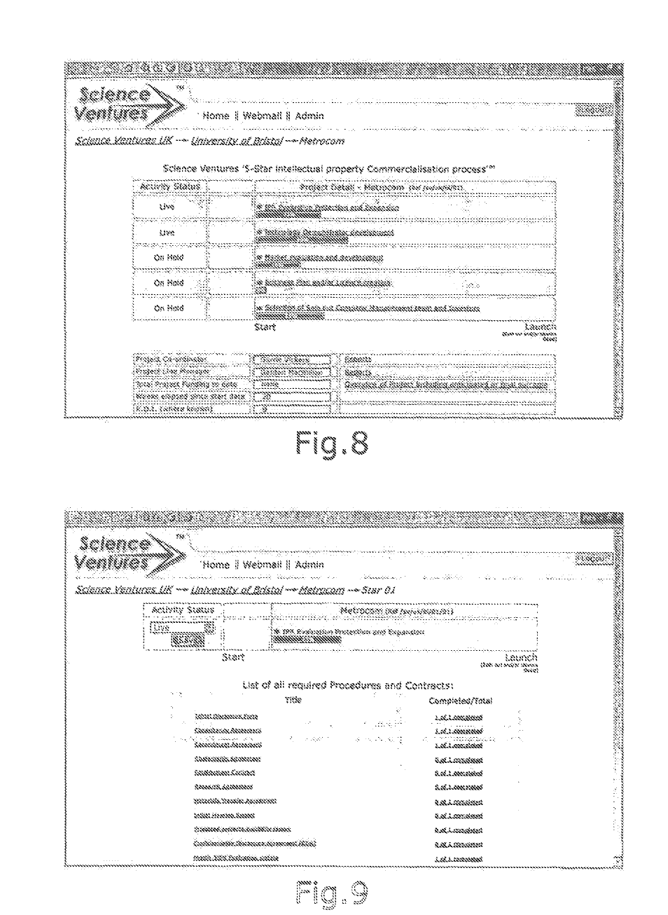

When the user selects a hyperlinked project title, they are then presented with a project-specific screen, as shown in FIG. 8. This gives each individual activity of the commercialisation process described above as an individual hyperlink, along with an indication of the progress of each step-in this example, this indicator is in the form of a coloured background representing a progress bar, showing progress of the activity from 0 to 100% complete. The project screen also includes an activity status indicator, to denote the status of each activity. There may also be, in certain embodiments of the invention, an indication of any unread messages for that user associated with each activity. The unread message indicator may be connected to a conventional email program or the like, or may be associated with a specifically-created mail routine limited to use within the commercialisation entity. In the described embodiment, however, a separate ‘webmail’ link is provided to allow a user to access a webmail client; no unread message indicator is provided in this embodiment. Also presented on the activity list screen is a ‘project overview’, in the form of brief information regarding the chief individuals involved in the project, overall duration and expenditure of the project, and the return on investment to date. Hyperlinks are also provided from each of these brief details to more comprehensive reports on each aspect of the project.

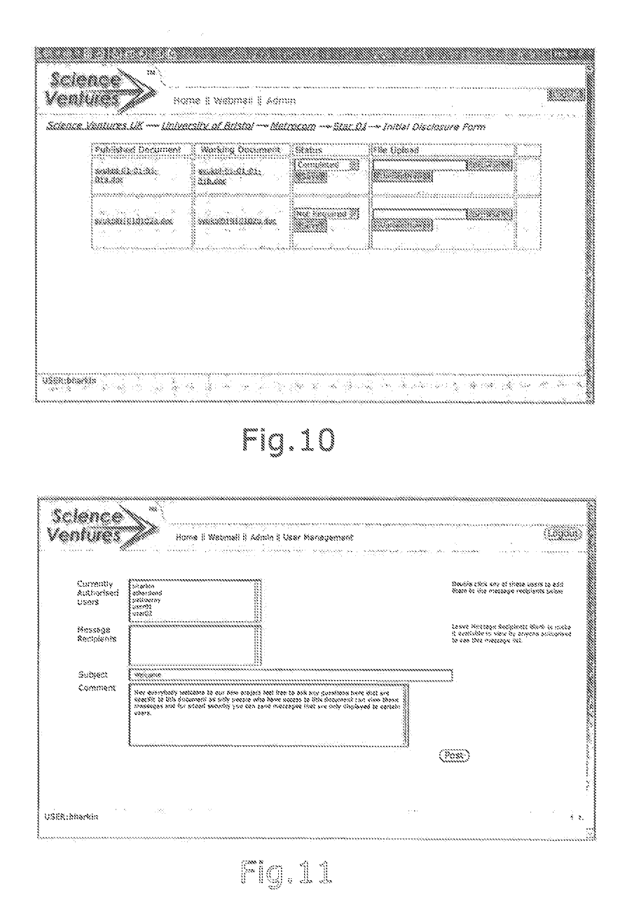

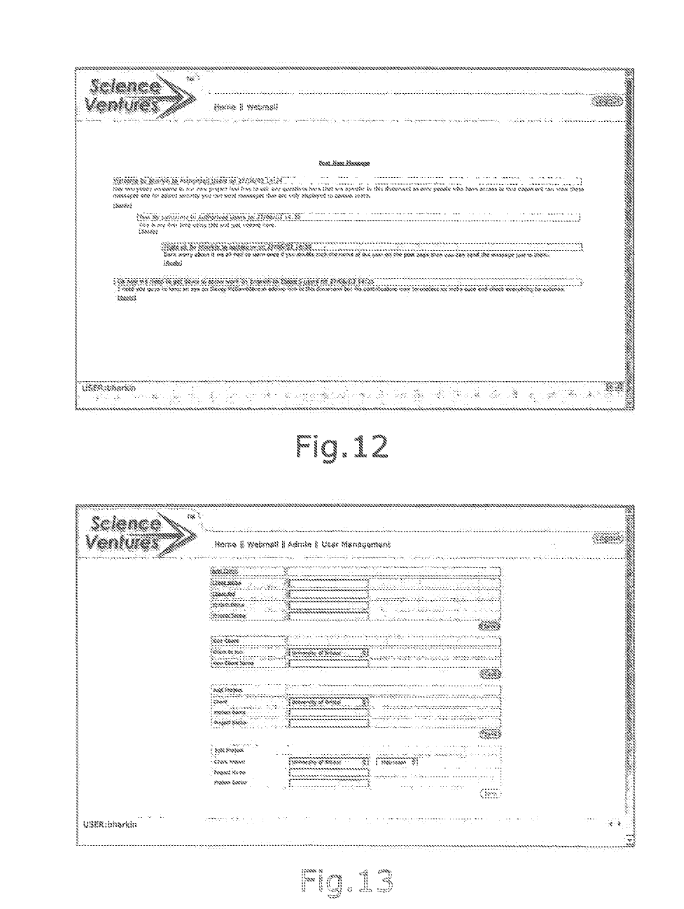

When the user selects a hyperlink from a particular activity, they are then presented with the document list screen (FIG. 9), which presents a list of titles of each document associated with that activity, along with a status indicator. Each document title is hyperlinked to the actual document, such that the user may access the document by simply clicking on the title (FIG. 10). The document list screen includes a representation of the progress of the relevant activity, for ease of reference. The document screen further allows users to upload amended or new documents to the project. The program further allows a user to access a webmail client, as briefly described above. Clicking on the ‘webmail’ hyperlink accesses a message screen (FIG. 11), which permits users to send email messages to defined participants in that project. The participants may be selected from a defined list of participants identified within the data storage means as being involved in that project. Each email message may automatically include headers identifying the relevant project, activity, and (if appropriate) document, so allowing the messages to be treated like any other document and accessed in a logical hierarchical manner. This webmail system allows messages to be sent only to participants in a particular project via the project management tool; an illustration of the received messages screen is given in FIG. 12. Certain embodiments of the invention may also include a fully-functional external webmail interface, permitting external mail to be sent (that is, mail to other than authorized participants). Access to such an external mail facility may itself be restricted to certain users, such as administrators or the like.

Thus, the computer program as described allows users to access a database or other data store including details of multiple commercialisation projects, each of which is using the commercialisation methodology described herein, and to access all relevant documentation, in a logical and hierarchical manner, so making it easier for the users to monitor and implement the commercialization procedure. The program also permits electronic communication between participants in a project, with the communications being grouped with the relevant activities and documents. Embodiments of the invention may also include a ‘search’ facility (not shown), allowing users to search for particular documents, projects, or users. Any suitable search program modules may be used; these will be known to the skilled person.

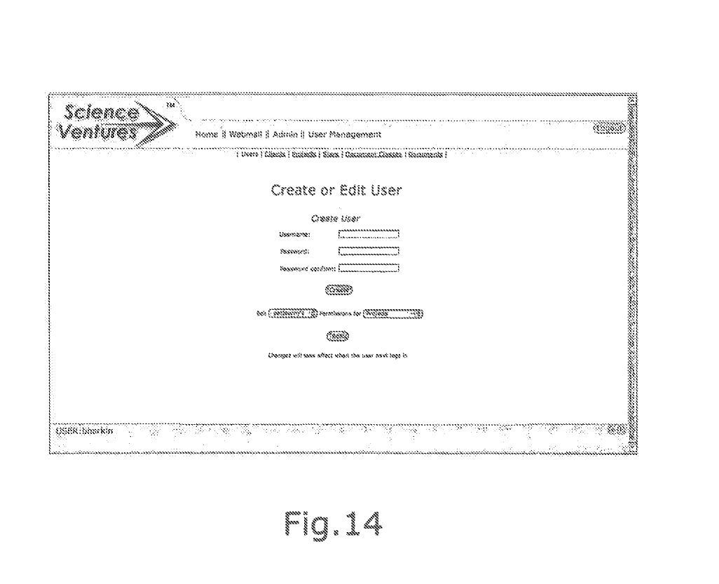

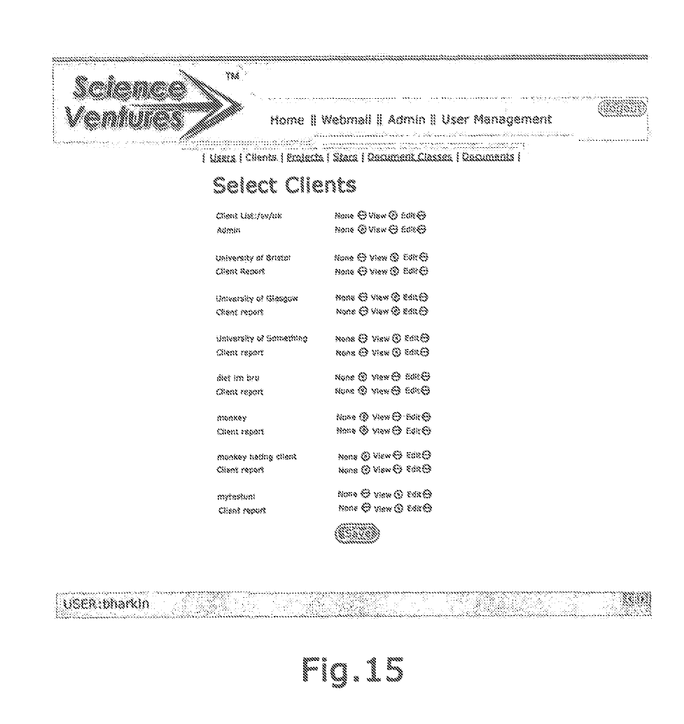

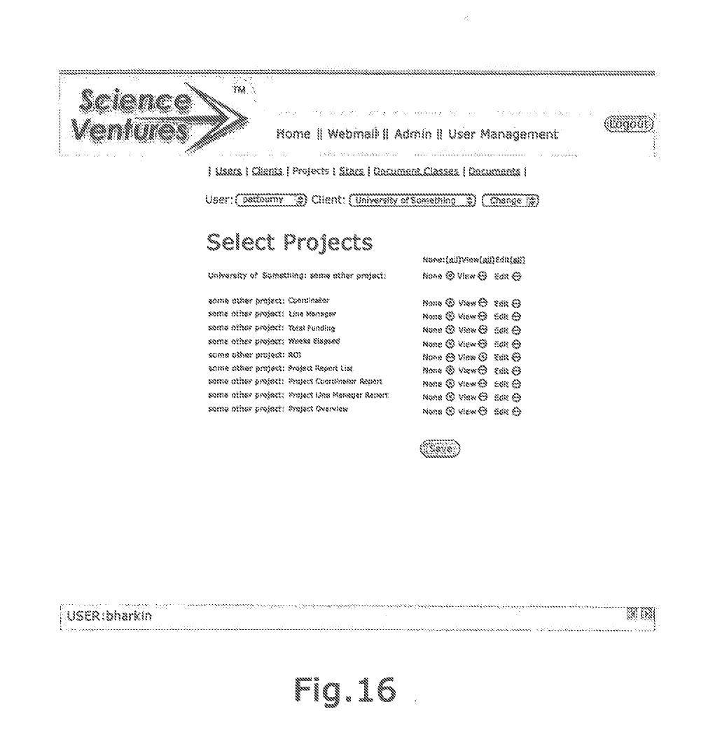

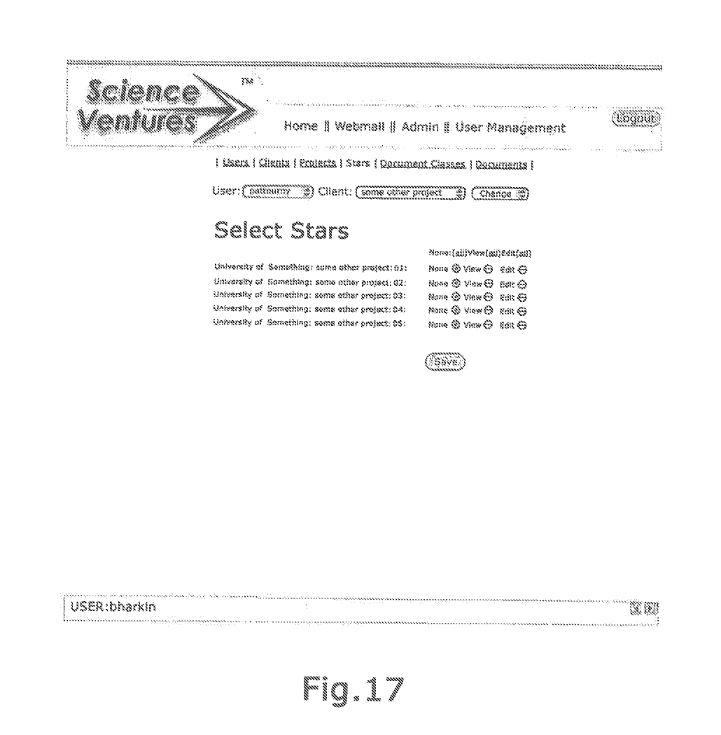

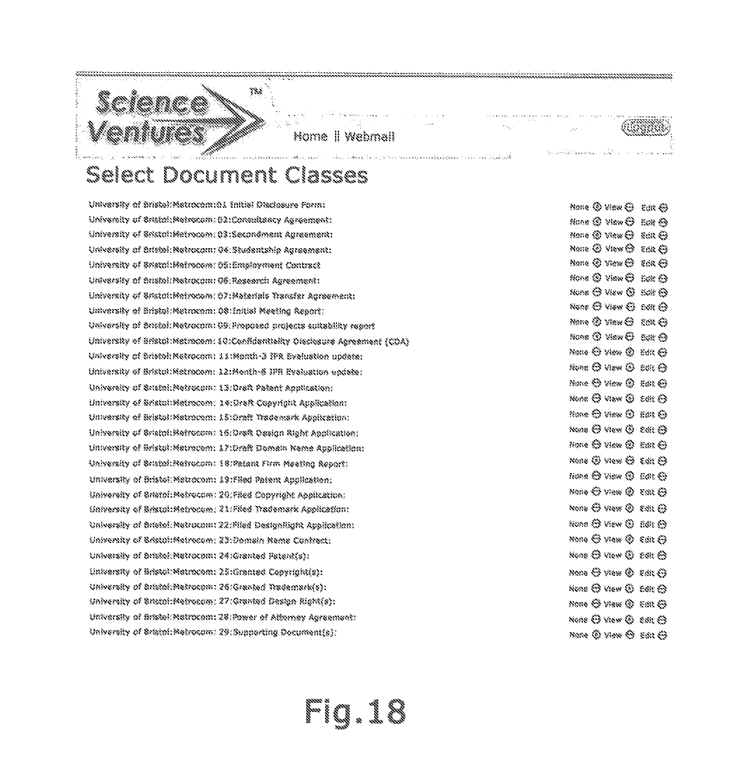

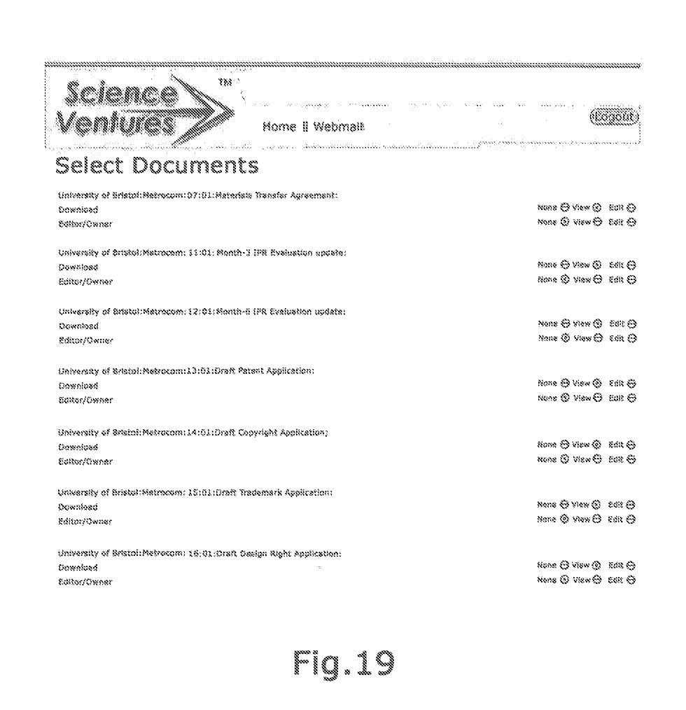

Suitably-authorised users may also access an ‘admin’ screen (shown in FIGS. 13 to 19) after logging in, which allows an administrator to create and edit new projects, users, documents, and the like. FIG. 13 shows a screen permitting addition of new clients and projects; a simple defined list of details are input, and suitable data structures created. A default list of documents and activities are automatically associated with each new project; however, these can be amended if desired by an administrator. Specific users can be granted access permission to newly-created projects, documents etc, to allow these new items to be read only, written, or neither, by the user. FIG. 14 illustrates a screen allowing creation of new users or editing of existing user details. Once a user has been created, details of their accessible documents and projects may be edited FIG. 15 shows the list of available clients, each of which can be defined such that the user has no access, view only access, or view and edit access. For each client, available projects can be edited (FIG. 16), as can particular steps within a project (FIG. 17), and documents for each step (FIG. 18). Once a user's access levels have been set, particular screens presented to that user will include only those items that they are permitted to access; for example, FIG. 19 shows a list of documents presented to a user with limited access to the full list of documents given in FIG. 18.

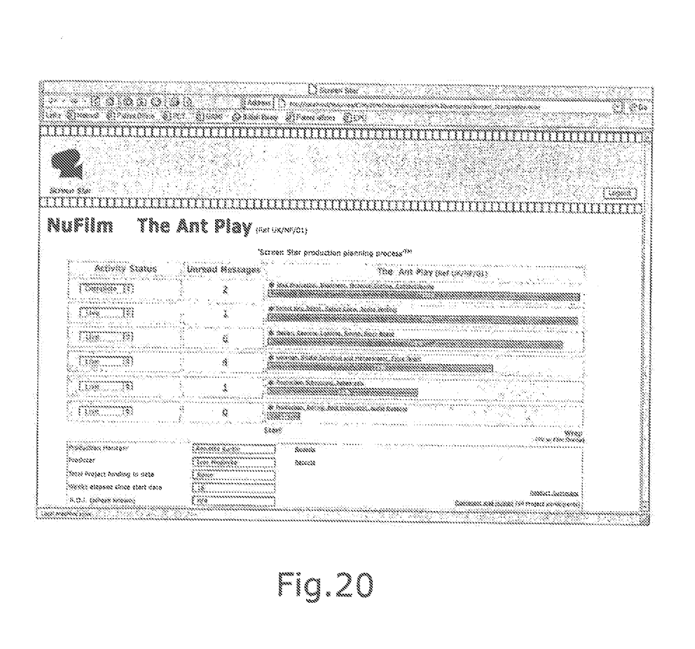

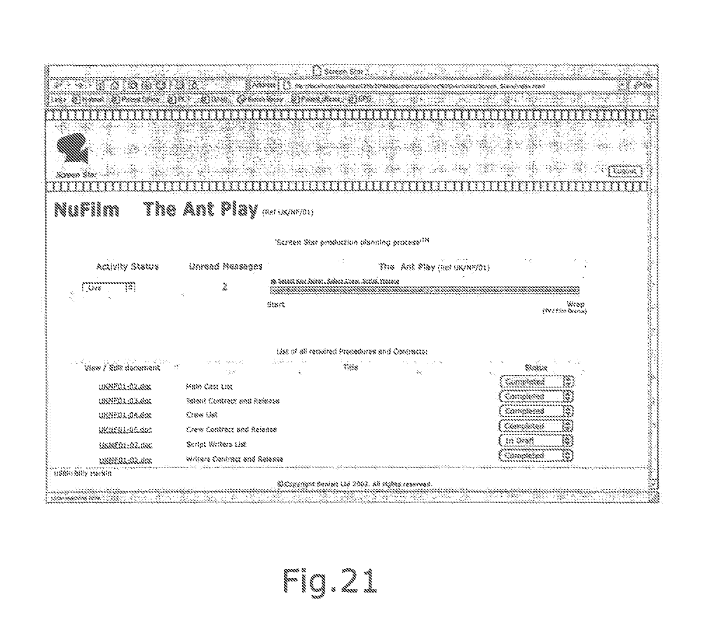

Referring now to FIGS. 20 and 21, these show simulated screenshots of a computer program for managing a project consisting of the production of a film for television. The project management is conceptually similar to that described above with reference to commercialisation of an invention, in that the project consists of a number of activities each of which must be completed before the project is completed, with each activity being associated with a number of documents. FIG. 20 shows the main project screen, and corresponds to FIG. 8 of the commercialization program. The main project screen illustrates each activity in the form of a bar chart indicating the percentage completion of the activity. In this example there are six activities-idea evaluation, treatment, technical outline, commissioning; select key talent, select crew, script writing; design, camera, lighting, sound, story board; location/studio selection and management, extra talent; production scheduling, rehearsals; and production, editing, post production, audio dubbing. Each of these activities is displayed along with a flag which indicates the status of the activity (completed, on hold, live, or not started), and an indication of whether any unread messages are associated with that activity. User selection of an unread message indicator will allow the user to view that message.

The lower portion of the screen displays the identities of key personnel involved in the project, and provides a user link to any reports prepared by those personnel.

User selection of a particular activity takes the user to the activity screen illustrated in FIG. 21; this corresponds to FIG. 9 of the commercialisation project. The activity screen includes a bar chart illustrating progress of the selected activity only, with the lower portion of the screen listing all documents associated with that activity. The status of the document (completed, draft, on hold, not yet started) is indicated, while the identity of each document is displayed as a hyperlink. User selection of the hyperlink opens the document itself in a new screen, allowing user editing (if appropriate permissions have been set) or viewing. The number of completed documents is converted into a percentage completion of the activity, for display in the bar chart.

The overall film-making project illustrated in these Figures proceeds along similar lines to the commercialization project described above, with the activities and documents themselves being different, but with the overall processes and relationships between activities, documents, and personnel being similarly organised.

A further modification of the invention allows a user to set up and define their own projects to be managed. A computer program may be provided allowing a user to define each activity within a project, together with the documents required as part of each activity. Lists of authorized personnel may also be provided, and the relationships between activities, documents, personnel, and the overall project may then be defined—for example, the order in which documents must be completed to progress the activity, and the percentage of completion that each document represents; the order of each activity, and which activities must be completed before subsequent ones may be begun; and the access level of each personnel member, in terms of which documents and activities they may have read and write access to, or only read access, or no access at all. This allows the project manager to rapidly and relatively straightforwardly adapt the invention described herein for use in new types of project as desired. The only limitation is that the project must be able to be codified into a series of activities each of which has associated documents. Such a modification of the invention will be seen to be very similar to the administration component of the computer program described with reference to FIGS. 13 to 19 above.

It will be understood that the foregoing is for descriptive purposes only, and that various modifications may be made to the described embodiments without departing from the scope of the invention. For this reason, the scope of the invention should be determined with reference to the appended claims.

For example, although the computer program has been described with reference to implementation of the commercialisation procedure and a film-making procedure, it will be apparent that similar programs may be used to monitor and implement other procedures which rely on a defined series of activities. Such programs may also be used to allow logical access to documents and information which may be classified in a hierarchical manner. For example, the program may be used to monitor and administer the conveyancing process involved in purchasing of property, in which multiple document checks and processes must be undertaken in a particular order, and in which it is helpful to be able to rapidly identify the status of certain processes before beginning others. Other possible types of project which may be administered include civil engineering projects, building construction and the like. Numerous other examples will be apparent to the skilled person.

One example given relates to a patentable invention but the generally inventive methodology is applicable to all forms of intellectual property rights.

I claim:

1. A system for use in commercialisation of intellectual property rights, the system comprising:
a data storage device including a plurality of data structures representing templates for documents for use in commercialization of intellectual property rights;
a computer processor in communication with the data storage device, for retrieving and manipulating the data structures;
a data input device for inputting data and commands to the computer processor;
an output means for outputting manipulated data structures from the computer processor; and
means for real time communication between the computer processor and a remote computer processor, said means for real time communication being selected from the group consisting of video-conferencing, internet telephone, and text-based messaging;
wherein the computer processor allows multiple users to access and amend the data structures in a single session.

2. The system of claim 1, wherein a plurality of computer processors and data input devices are provided.

3. The system of claim 1, further comprising non-real time communication means coupled to the computer processor, the non-real time communication means being selected from the group consisting of email and webmail facilities.

4. The system of claim 1, further comprising access regulation means for restricting access to the data storage device, the access regulation means being selected from the group consisting of system privileges and password protection.

5. The system of claim 1, wherein the data structures are selected from one or more of: project plans, invention disclosure forms, licence agreements, business plans, and contracts for outside suppliers.

6. A project management system comprising:
a data storage device including a plurality of data structures representing templates for documents for use in management of a project;
a computer processor in communication with the data storage device, for retrieving and manipulating the data structures;
a data input device for inputting data and commands to the computer processor; and
an output means for outputting manipulated data structures from the computer processor.
